(19) United States
(12) Patent Application Publication
(10) Pub. No.: US 2011/0236519 A1
(43) Pub. Date: Sep. 29, 2011

(54) AUXETIC FOAM MANUFACTURING SYSTEM

(75) Inventor: David Skertchly, Hampshire (GB)

(73) Assignee: Global Composites Group, Buckinghamshire (GB)

(21) Appl. No.: 13/126,248

(22) PCT Filed: Oct. 16, 2009
(86) PCT No.: PCT/GB2009/051388

§ 371 Date: Jun. 2, 2011

(30) Foreign Application Priority Data
Oct. 29, 2008 (GB) 0819885.5

(51) Int. Cl. B29C 43/52

(52) U.S. Cl. 425/335

(57) ABSTRACT

An apparatus for the continuous production of an auxetic foam, comprising a tunnel (17) comprising a compression section with an inlet and an outlet for compressing foam in at least one axis as it moves from the inlet to the outlet, means (13, 14, 15, 16) to propel a foam material through the tunnel (17) from the inlet to the outlet, and heating means to heat foam passing through the compression section (11) to a temperature higher than its glass transition temperature.

### BACKGROUND

The current invention relates to the manufacture of auxetic foam and in particular to the continuous manufacture of auxetic foam.

The Poisson's ratio of a material is a measure of its expansion or contraction in a direction perpendicular to an applied strain. Materials with a positive Poisson's ratio contract in a direction perpendicular to an applied tensile strain whereas materials having a negative Poisson's ratio expand in a direction perpendicular to an applied tensile strain. Materials having a negative Poisson's ratio are known as auxetic materials.

It has been shown that small quantities of auxetic foam can be formed by the tri-axial compression of pieces of non-auxetic foam. However, such production techniques are limited to batch production and are difficult to scale to industrially practical quantities.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided an apparatus for the continuous production of an auxetic foam, comprising a tunnel comprising a compression section with an inlet and an outlet for compressing foam in at least one axis as it moves from the inlet to the outlet, means to propel a foam material through the tunnel from the inlet to the outlet, and heating means to heat foam passing through the compression section to a temperature higher than its glass transition temperature.

The walls of the tunnel may be movable surfaces which provide the means to propel the foam material.

The means for propelling the foam may comprise rollers.

The tunnel may further comprise an feed section which forms the inlet of the compression section, the feed section having heating means for heating foam in the feed section prior to it passing to the compression section.

The foam within the feed section may be heated to close to the foam's glass transition temperature prior to its passage into the compression section.

The foam may be heated to 1 to 5° C. below the foam's glass transition temperature in the feed section.

One dimension of the compression section perpendicular to the direction of movement of the foam may decrease from the inlet to the outlet of the compression section.

Both dimensions of the compression section perpendicular to the direction of movement of the foam may decrease from the inlet to the outlet of the compression section.

The tunnel may further comprise an outlet section which forms the outlet of the compression section, the outlet section having cooling means for cooling foam in the outlet section to below its glass transition temperature.

The foam may be heated to 2 to 5° C. above its glass transition temperature in the compression section.

### DESCRIPTION OF THE DRAWINGS

Embodiments of the present invention will now be further described, by way of example, with reference to the drawings, wherein:

FIG. 1 shows a schematic diagram of an apparatus for the continuous production of auxetic foam; and

FIG. 2 shows a cross-section of the apparatus shown in FIG. 1.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

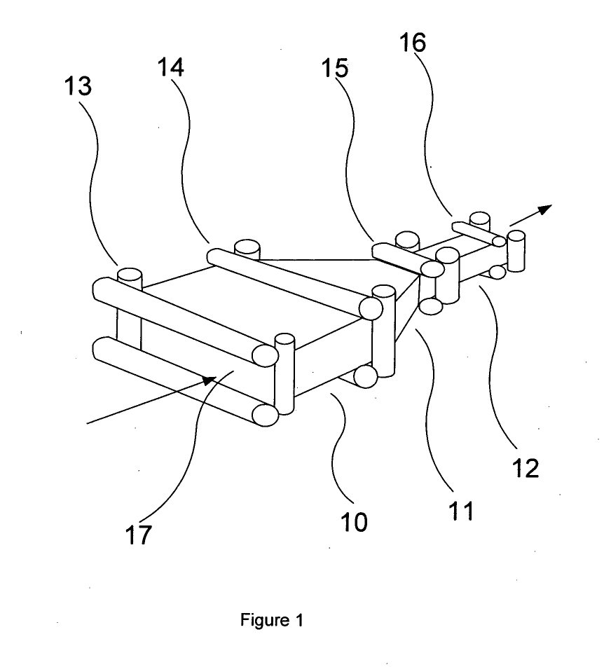

FIG. 1 shows an apparatus for the continuous production of auxetic foam. The apparatus comprises three sections, a feed section 10, a compression section 11 and an outlet section 12. Powered rollers 13, 14, 15, 16 are positioned at the start and end of each section to convey material through the apparatus. Sections 10, 11, 12 are defined by walls for guiding material through the apparatus. Openings in the walls are provided such that rollers 13, 14, 15, 16 protrude into the tunnel 17 and impinge on material in that tunnel.

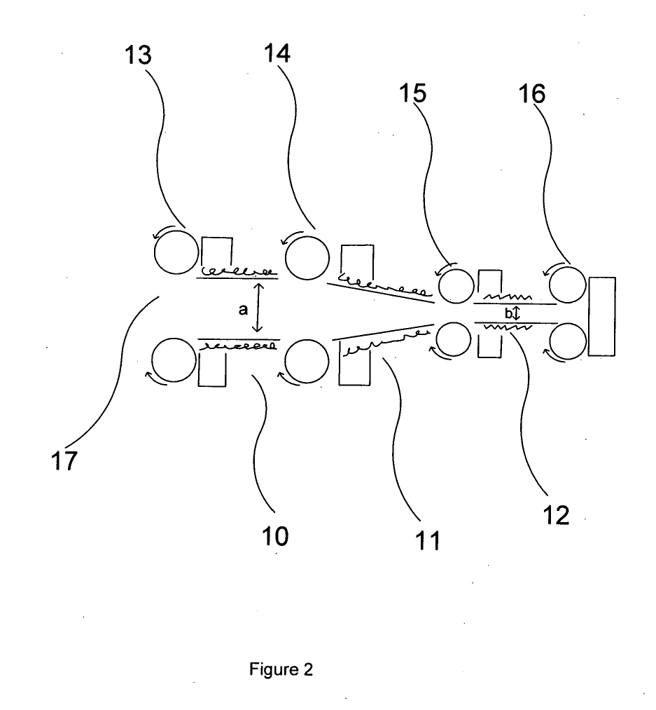

FIG. 2 shows a cross section of the apparatus of FIG. 1.

To produce an auxetic foam a non-auxetic foam feedstock is fed into the input of feed section 10. Rollers 13 are powered to push the feedstock into the feed section 10. Within the feed section 10 the foam is heated to close to its glass-transition temperature. For example, it may be heated to 1 to 5° C. below the glass transition temperature. The temperature is selected such that the foam retains its stiffness. For example for a polypropylene with a transition temperature of 170° C., the processing temperature would be between 170 and 165° C. Temperature differences of greater than 5° C. may also be appropriate for certain foams. Heating of the foam may be achieved by heating one or more of the walls and rollers of the inlet section, but as will be appreciated any suitable heating method may be employed. The temperature of the walls and rollers, and speed of roller movement, is selected such that the foam reaches the required temperature at the end of the inlet section.

Rollers 14 transfer the material from the inlet section 10 into the compression section 11. While in the compression section 11, the foam is heated to above its glass transition temperature. For example, the foam may be heated to 2 to 5° C. above the glass transition temperature. For example, for a polypropylene having a glass transition temperature of 170° C. the temperature would may be 172° C. to 175° C.

As the foam passes along the compression section it is compressed in both axes in a plane perpendicular to the direction of movement. Rollers 14, 15 are powered at different speeds, with rollers 14 rotating faster than rollers 15. The differential speed acts to compress the foam in the longitudinal axis, in addition to the compression achieved by the converging walls in the other two axes. The foam is therefore compressed in all three axes as it passes through the compression section. Typical compression ratios may be between 30 and 70%, but are determined by the material types and other process parameters.

Rollers 15 convey the compressed material into the outlet section 12 where it is cooled. Cooling may be achieved by one or more of rollers 15, 16 and the walls of the outlet section 12 being cooled.

Compression of the foam in the compression section, while it is above its glass transition temperature, leads to a crumpling of the foam cell walls. That crumpling may impart a negative Poisson's ratio to the foam, provided the temperature and compression ratios are correctly selected. The foam is compressed in all three axis during passage through the apparatus and thus a negative Poisson's ratio may be achieved in all three axes.

In an alternative apparatus the compression section only tapers in a single axis while remaining a constant size in the other axis. The apparatus thereby compresses the foam in two axes (longitudinal and one perpendicular to the direction of travel of the foam), leading to a foam having a negative Poisson's ratio in only two axes.

In a further alternative, the compression section may be replaced by a straight section which does not compress the foam perpendicular to the direction of travel. The foam is thus only compressed in a single axis (longitudinal with the direction of movement), resulting in a foam with a negative Poisson's ratio in only a single-axis.

Any combination of differential roller speeds and compression sections may be utilised to compress the foam in the desired axes in order to produce foam having a negative Poisson's ratio in define axes. For example, single or double axis compression perpendicular to the movement direction may be combined with compression, or with no compression, in the longitudinal axis.

The walls and/or rollers may be vibrated to affect the friction with the foam and/or to apply further compression to the foam.

The apparatus, and method of producing auxetic foam using that apparatus, is suitable for processing thermoplastic and thermosetting plastic foams which have a glass transition temperature.

The apparatus may be formed as a series of conveyors to move and compress the foam through the tunnel in place of the plates and rollers. Furthermore only some of the rollers in the embodiment described above may be powered, or none may be powered and an alternative means of conveying the foam through the tunnel may be provided. Any suitable method of powering the rollers to convey the material through the tunnel may be utilised. The embodiment shown above comprises rollers at the transitions between the sections but more, or fewer, rollers may be provided. For example, rollers may also be provided within certain of the sections.

The inlet and outlet sections of the apparatus described above are provided to allow convenient heating and cooling of the foam. Those sections may be replaced by any suitable means for providing foam feedstock at an appropriate temperature to the compression section and for removing the compressed foam from the compression section. The outlet section must hold the foam in the compressed state until cooling is complete such that the foam retains its compressed form.

It will be understood that the benefits and advantages described above may relate to one embodiment or may relate to several embodiments. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. An apparatus for the continuous production of an auxetic foam, comprising:
a tunnel comprising a compression section with an inlet and an outlet for compressing foam in at least one axis as it moves from the inlet to the outlet;
means to propel a foam material through the tunnel from the inlet to the outlet; and
heating means to heat foam passing through the compression section to a temperature higher than its glass transition temperature.

2. An apparatus according to claim 1, wherein the walls of the tunnel are movable surfaces which provide the means to propel the foam material.

3. An apparatus according to claim 1, wherein the means for propelling the foam comprise rollers.

4. An apparatus according to claim 1, wherein the tunnel further comprises a feed section which forms the inlet of the compression section, the feed section having heating means for heating foam in the feed section prior to it passing to the compression section.

5. An apparatus according to claim 4, wherein foam within the feed section is heated to close to the foam's glass transition temperature prior to its passage into the compression section.

6. An apparatus according to claim 5, wherein the foam is heated to 1 to 5° C. below the foam's glass transition temperature in the feed section.

7. An apparatus according to claim 1, wherein one dimension of the compression section perpendicular to the direction of movement of the foam decreases from the inlet to the outlet of the compression section.

8. An apparatus according to claim 1, wherein both dimensions of the compression section perpendicular to the direction of movement of the foam decrease from the inlet to the outlet of the compression section.

9. An apparatus according claim 1, wherein the tunnel further comprises an outlet section which forms the outlet of the compression section, the outlet section having cooling means for cooling foam in the outlet section to below its glass transition temperature.

10. An apparatus according to claim 1, wherein the foam is heated to 2 to 5° C. above its glass transition temperature in the compression section.
